(19) United States
(12) Patent Application Publication
(10) Pub. No.: US 2025/0318977 A1
(43) Pub. Date: Oct. 16, 2025

(54) Flexible Full-Length Back and Spine Stretching Device with Individually Material-Encased and Adaptive Massage Nodes for Dynamic Support and Enhanced Ergonomics

(71) Applicants: Rene Jon Hart, New Canaan, CT (US); David Yang, Santa Ana, CA (US)

(72) Inventors: Rene Jon Hart, New Canaan, CT (US); David Yang, Santa Ana, CA (US)

(21) Appl. No.: 19/172,939

(22) Filed: Apr. 8, 2025

Related U.S. Application Data
(60) Provisional application No. 63/632,348, filed on Apr. 10, 2024.

(51) Int. Cl. A61H 1/02; A61H 7/00

(52) U.S. Cl. CPC A61H 1/0292; A61H 7/001; A61H 2201/0103; A61H 2201/0146; A61H 2201/0192; A61H 2201/1685; A61H 2201/1695; A61H 2203/0456

(57) ABSTRACT

A therapeutic device for back and spine relief is disclosed, comprising a flexible core structure and a plurality of massage nodes distributed along its length. Each massage node is individually encased in a soft, durable material, allowing the device to conform to a user's back for targeted pressure and ergonomic support. The device is configurable into multiple orientations, including a flat configuration for general support, a rolled configuration for concentrated pressure, and a draped configuration for seated use. In some embodiments, massage nodes include air-filled chambers for adjustable firmness, and the device may be constructed in modular segments for customized length, curvature, and node distribution. The invention addresses limitations of conventional back therapy devices by offering enhanced adaptability, comfort, and portability, making it suitable for home, office, or travel use. This device provides a comprehensive and user-adjustable solution for spinal decompression, muscle relief, posture correction, and general back care.

### FEDERALLY SPONSORED RESEARCH

Not Applicable

### SEQUENCE LISTING OR PROGRAM

Not Applicable

### FIELD OF THE INVENTION

The present invention relates generally to therapeutic and ergonomic devices for back and spinal care, and more specifically to a flexible, full-length spine stretching and massage device incorporating material-encased massage nodes for dynamic, customizable support and relief. The invention is particularly suited for users seeking adaptable solutions for posture correction, spinal decompression, muscle relaxation, and general back wellness.

### BACKGROUND OF THE INVENTION

Back pain and spinal discomfort are among the most common health complaints worldwide, often resulting from sedentary lifestyles, repetitive strain, poor posture, or chronic musculoskeletal conditions. A wide variety of therapeutic devices have been developed to address these issues, ranging from rigid spinal stretchers and foam rollers to electric massage chairs and posture braces.

However, many conventional devices suffer from one or more limitations. Rigid structures frequently fail to conform to the natural curvature of a user's spine, limiting their effectiveness and comfort. Devices with fixed massage elements often cannot target specific pressure points or accommodate different body types, which reduces their therapeutic benefit. Furthermore, most existing solutions are designed for stationary use in limited settings and are not easily adaptable to varying environments such as home, office, or travel.

Additionally, many therapeutic devices offer limited customization in terms of support level, massage intensity, or configuration. Users are often unable to modify these devices to suit their unique needs, whether seeking deep pressure in one session or gentle support in another. This lack of flexibility, combined with issues of portability and convenience, restricts the broader applicability of such devices in everyday use.

There is, therefore, a longstanding and unmet need in the field of therapeutic back care for a device that integrates comfort, configurability, ergonomic adaptability, and user-specific customization into a single, easy-to-use system. The present invention addresses these deficiencies by introducing a novel back and spine stretching and massage device that provides dynamic support through flexible structural components and material-encased massage nodes. The device's unique ability to conform to the user's back, its versatility in configuration (flat, rolled, or draped), and its support for modular adjustment make it a superior alternative to existing therapeutic products on the market.

### SUMMARY OF THE INVENTION

The present invention introduces a novel spine stretching and massage device engineered to deliver comprehensive relief for the back and spine through an innovative fusion of flexibility, adaptability, and comfort. Distinguished from conventional therapeutic devices, this invention features a series of individually encased massage nodes that enhance both effectiveness and user comfort. The design allows the device to be rolled into a double or multi-stack configuration, giving users the ability to tailor the level of support and stretch to their unique physical needs. This adjustability makes it suitable for a wide range of users, from those requiring deep tissue pressure to individuals needing gentler support for sensitive areas.

The spine stretcher and massage device is also adaptable for use in seated positions, as it can be conveniently draped over various types of chairs. This functionality extends its use beyond traditional therapy settings, transforming it into a practical, everyday support tool. A key innovation lies in the material encasement of the massage nodes, which ensures a soft yet effective massage that conforms to the contours of the user's back. The chosen material provides durability, flexibility, and ease of maintenance, making the device both comfortable and practical.

Overall, the invention excels in its ability to adapt to diverse body types and usage scenarios, allowing users to personalize their therapy experience through adjustable pressure and positioning. It offers a soothing, effective treatment method that is both easy to use and maintain, thereby addressing the limitations of existing spine therapy devices with a more versatile, comfortable, and user-friendly solution.

### REFERENCE CHARACTER LIST

1—Therapeutic Device. The entire back and spine stretching and massage device as a whole unit, demonstrating its functionality and adaptability.
2—Massage Nodes. The individual elements within the therapeutic device that provide massage and pressure to the user's body, specifically designed to conform to the user's back and spine.
3—Encasing Material. The material that encases the massage nodes, contributing to the comfort and adaptability of the therapeutic device.
4—Stitching. The seams or stitching that define the compartments or pockets within the therapeutic device that house the massage nodes.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a top plan view of the therapeutic device in a flat configuration, showing the arrangement of material-encased massage nodes along the flexible core.

FIG. 2 is a side elevation view of the device, illustrating the raised and recessed contours formed by the massage nodes to correspond with the curvature of the spine.

FIG. 3 is a perspective view of the device in a partially rolled configuration, demonstrating its use for targeted support in the cervical or thoracic region.

FIG. 4 shows the device in a fully rolled configuration for compact storage or for localized pressure application to areas such as the lumbar spine.

### DETAILED DESCRIPTION OF THE INVENTION

The subject matter of the present invention now will be described more fully hereinafter with reference to the accompanying drawings, in which some, but not all embodiments of the subject matter of the present invention are shown. Like numbers refer to like elements throughout. The subject matter of the present invention may be embodied in many different forms and should not be construed as limited to the embodiments set forth herein; rather, these embodiments are provided so that this disclosure will satisfy applicable legal requirements. Indeed, many modifications and other embodiments of the subject matter of the present invention set forth herein will come to mind to one skilled in the art to which the subject matter of the present invention pertains having the benefit of the teachings presented in the foregoing descriptions and the associated drawings. All illustrations of the drawings are for the purpose of describing selected versions of the present invention and are not intended to limit the scope of the present invention. Therefore, it is to be understood that the subject matter of the present invention is not to be limited to the specific embodiments disclosed and that modifications and other embodiments are intended to be included within the scope of the appended claims.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above- disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and example of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein-as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one”, but does not exclude a plurality unless the contextual use dictates otherwise. When used herein to join a list of items, “or” denotes “at least one of the items”, but does not exclude a plurality of items of the list. Finally, when used herein to join a list of items, “and” denotes “all of the items of the list”.

The present invention discloses a therapeutic device configured for comprehensive back and spine relief. The device is particularly designed to address limitations in conventional spinal support and massage tools by offering enhanced flexibility, adaptability, ergonomic comfort, and a range of customizable features. It is suitable for use across a variety of physical environments and user needs, including back support, spinal decompression, posture correction, and muscle relaxation.

The device is configurable in multiple orientations, including a flat configuration for general back support, a stacked or rolled configuration for localized deep tissue pressure, and a draped configuration for seated use. These multiple configurations allow users to tailor their therapeutic experience to specific needs such as spinal decompression, postural support, or muscle recovery. The invention also includes embodiments that support modular customization of massage node quantity, spacing, shape, and firmness-features that enable a highly personalized and effective therapy session.

In certain embodiments, massage nodes may include air-filled chambers for adjustable pressure control. The flexible structure and portability of the device further enable its use in diverse settings, including home, office, travel, or clinical environments. The combination of these features distinguishes the invention from prior art by offering an integrated, ergonomic, and user-centric approach to back and spine wellness.

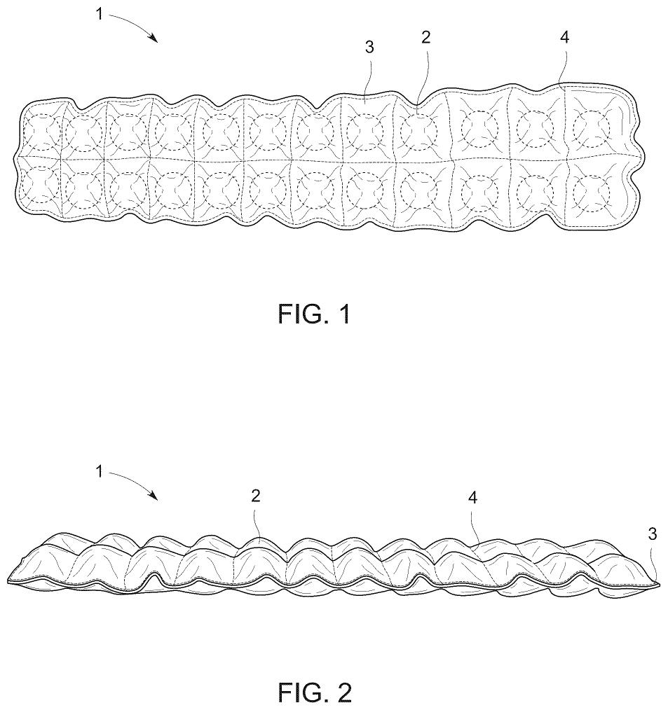

As shown in FIG. 1, the therapeutic device (1) comprises a flexible full-length core substrate, along which a plurality of massage nodes (2) are distributed in a generally uniform pattern. These massage nodes are each individually encased in a soft, durable material (3), and retained within stitched or heat-sealed pockets (4) that allow them to remain fixed in position while still offering some relative mobility. The top plan view in FIG. 1 illustrates the overall flat configuration of the device, showing how the uniform distribution of massage nodes enables consistent therapeutic pressure along the full length of a user's back.

The core substrate is formed from a pliable, resilient material that allows the entire device to bend, roll, or flex without losing structural integrity. The encasing material surrounding each massage node is selected for tactile comfort, elasticity, and resistance to wear, enabling the device to adapt to the contours of the human body while maintaining effectiveness during prolonged use.

The massage nodes themselves are designed to apply varying degrees of pressure to the back and spine. These nodes may be spherical, semi-spherical, polyhedral, or custom-contoured to match the user's spine and musculature. The device is designed to accommodate a wide range of node sizes and shapes, depending on the desired therapeutic application.

FIG. 1 not only illustrates the device in its flat form but also demonstrates the potential for stacked configurations. In this mode, the user may roll a portion of the device into one or more layers to increase elevation and support, thereby modifying the intensity and area of application. This adjustability enables focused support for specific areas along the spine such as the lumbar or cervical regions.

FIG. 2 provides a side elevation view of the device, showing an undulating configuration created by the raised and recessed regions formed by the massage nodes. This wave-like structure naturally aligns with the curvature of the human spine, particularly the cervical, thoracic, and lumbar regions. The configuration facilitates a dynamic therapeutic experience by applying variable pressure points tailored to the anatomical profile of the user. It also highlights the device's capacity to be bent or curved into non-planar forms, supporting diverse modes of engagement and massage depth.

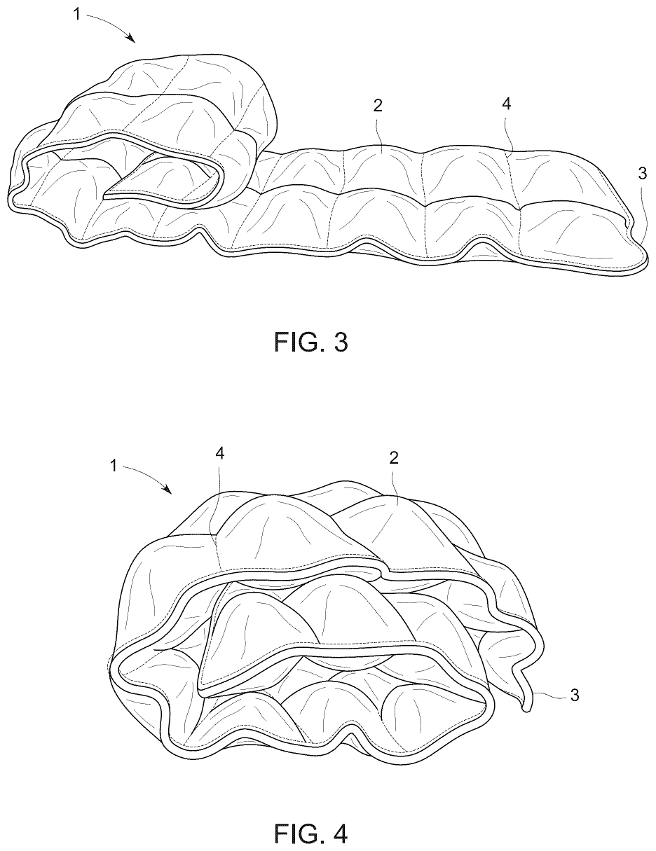

FIG. 3 depicts a perspective view of the device in a partially rolled configuration, specifically targeting the neck and shoulder areas. In this elevated position, the massage nodes exert a concentrated force that is ideal for relieving cervical tension and shoulder stiffness. This rolled use-case exemplifies the device's adaptability for localized musculoskeletal therapy, especially in cases of tech-neck, tension headaches, or rotator cuff strain. It further illustrates how the device transitions seamlessly between therapeutic modalities through simple manual adjustments.

FIG. 4 illustrates the device in a fully rolled, compact configuration, resembling a ball- like structure. This form allows for deep pressure application to localized regions such as the lower back or mid-thoracic spine. Additionally, this compact configuration demonstrates the device's portability and ease of storage, making it suitable for on-the-go use or environments with limited storage space. The rolled structure also enhances pressure intensity for users requiring a higher degree of stretch or decompression.

The device supports multiple operational modes:

Flat Configuration—The user lays the device flat on the floor or bed to achieve broad, uniform support. This mode promotes overall spinal alignment and muscle relaxation and is suitable for general use across the full length of the back.

Rolled/Stacked Configuration—By rolling the device into one or more layers, the user can elevate specific regions to provide increased stretching or focused pressure. This configuration is ideal for users requiring enhanced decompression or targeted muscle release.

Draped Configuration—The device may also be draped over the backrest of a chair, allowing seated users to benefit from passive support and massage. This usage mode supports better posture and can mitigate the effects of prolonged sitting.

The device may be manufactured in multiple sizes and configurations to suit different users, including children, petite adults, and individuals with broader or taller frames.

Additionally, massage nodes may be fabricated from materials of varying firmness, and may feature interior chambers capable of being filled with air or other fluids for adjustable pressure control. In alternative embodiments, firmness of the massage nodes may be adjusted via material selection (e.g., varying durometer elastomers), structural layering (e.g. inclusion of foam or textile overlays), or geometric design (e.g., node wall thickness, void ratios), in addition to inflation-based methods.

In embodiments utilizing air-filled chambers, users may inflate or deflate individual nodes to achieve desired firmness levels.

An additional embodiment includes modular construction, whereby segments of the device are interchangeable. Users can add or remove sections to adjust the length, curvature, or spacing of massage nodes, thereby customizing the device for specific body types or targeted therapy. Such modularity also supports maintenance and upgrades, as components can be replaced or updated individually without requiring full device replacement.

The nodes may also be implemented in various three-dimensional geometric shapes, including but not limited to spherical polyhedrons, tetrahedrons, or custom-molded anatomical shapes, to provide different massage effects. These designs may be used in combination across the device to create a multi-textural therapeutic surface.

In some embodiments, the entire device or individual modules may be water-resistant or buoyant, supporting use in water-based therapy environments such as pools or hydrotherapy tanks.

Through its adaptable configurations, ergonomic structure, customizable components, and versatile usability, the present invention delivers a comprehensive therapeutic tool for back and spine care that is superior to conventional rigid or single-use devices. The design accommodates a wide spectrum of musculoskeletal needs, supporting both active engagement and passive use, while offering portability, comfort, and user-specific customization.

The present invention offers a uniquely adaptable solution for back and spine therapy, distinguished by its ability to conform to various body shapes and sizes. Its flexible design allows for use in multiple settings, including while seated, making it suitable for both therapeutic and everyday ergonomic support. This adaptability ensures that users of different physical profiles can experience effective and targeted relief.

A key feature of the device is its high level of customization. Users can easily adjust the area and intensity of support or stretching by rolling or repositioning the device to suit their individual needs. Whether seeking gentle support or deeper pressure, the invention accommodates a wide range of therapeutic preferences through simple, user-driven adjustments.

The inclusion of material-encased massage nodes enhances overall comfort, delivering a soothing and effective massage experience that conforms to the user's spine and musculature. Combined with its ease of setup, use, and maintenance, the device presents a highly user-friendly and low-maintenance therapeutic tool.

Overall, this invention overcomes the rigidity and limited functionality of existing spine care devices by providing a versatile, comfortable, and fully adjustable system designed to support back health, posture, and muscle recovery in a wide variety of environments.

All publications, patent applications, patents, and other references mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference.

It will be understood that, although a number of patent applications, patents, and other references are referred to herein, such reference does not constitute an admission that any of these documents forms part of the common general knowledge in the art.

Although the foregoing subject matter has been described in some detail by way of illustration and example for purposes of clarity of understanding, it will be understood by those skilled in the art that certain changes and modifications can be practiced within the scope of the appended claims.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

What is claimed is:

1. A therapeutic device for back relief, comprising:
a flexible core structure;
a plurality of massage nodes disposed along the flexible core structure;
wherein each massage node is individually encased in a flexible, durable material; and
wherein the device is configurable between a flat configuration, a stacked configuration, and a draped configuration for therapeutic use.

2. The therapeutic device of claim 1,
wherein the massage nodes are modular in structure, permitting selective removal or addition of nodes to customize therapeutic coverage; and
the firmness of the massage nodes is adjustable via material selection of materials having varying durometer elastomers, structural layering including foam or textile overlays, or geometric design selecting node wall thickness and void ratios.

3. The therapeutic device of claim 1, wherein
the flexible core structure comprises a pliable connective substrate that enables the device to roll and bend while maintaining node alignment.

4. The therapeutic device of claim 1, wherein
at least one of the massage nodes includes an air-filled chamber configured to be inflated or deflated to adjust firmness.

5. The therapeutic device of claim 1,
wherein the encasing material conforms to a user's spinal curvature during use to provide targeted relief and support.

6. The therapeutic device of claim 1, further comprising
modular segments connectable to one another, wherein each segment comprises a portion of the flexible core and one or more massage nodes.

7. The therapeutic device of claim 1, wherein
the device is configured to be draped over a chair back to provide massage and posture support during seated use.

8. The therapeutic device of claim 1, wherein
the massage nodes are geometrically shaped to match spinal anatomy and are selected from the group consisting of spherical, semi-spherical, and polyhedral shapes.

9. The therapeutic device of claim 1, wherein
the flexible core includes stitching between adjacent massage nodes to define compartments that maintain their relative position during flexion.

10. The therapeutic device of claim 1, wherein
the flexible core and massage node arrangement is adapted to span the full length of a user's back, from the cervical region to the lumbar region.

11. A method of using a therapeutic device for back relief, comprising the steps of:
placing the device on a flat surface in a flat configuration;
positioning a user's back onto the device; and
allowing the massage nodes to provide pressure along the spine.

12. The method of claim 11, further comprising the step of
rolling the device into a stacked configuration to elevate a portion of the massage nodes and provide increased localized pressure.

13. The method of claim 11, further comprising the step of
draping the device over a chair back and using the device to provide seated back support and massage.

14. The method of claim 11, further comprising the step of
adjusting the quantity and arrangement of massage nodes to correspond to the user's therapeutic needs via material selection of materials having varying durometer elastomers, structural layering including foam or textile overlays, or geometric design selecting node wall thickness and void ratios.

15. The method of claim 11, further comprising the step of
adjusting the firmness of one or more massage nodes by altering the internal air pressure of air-filled chambers.

16. The method of claim 11, further comprising the step of
targeting a specific region of the spine by positioning a rolled section of the device beneath the cervical, thoracic, or lumbar region.

17. The method of claim 11, further comprising the step of
attaching or detaching modular segments of the device to change the overall length and curvature of the device.

18. The method of claim 11, further comprising the step of
selecting massage nodes having different geometrical shapes to achieve distinct massage effects.

19. The method of claim 11, further comprising the step of
using the device during extended seated activities to support spinal alignment and reduce back strain.

20. The method of claim 11, further comprising the step of
rolling the device into a compact configuration for use in localized stretching or for compact storage.
